(19) United States
(12) Patent Application Publication
(10) Pub. No.: US 2024/0321100 A1
(43) Pub. Date: Sep. 26, 2024

(54) MOTOR VEHICLE SAFETY INFORMATION SYSTEM

(71) Applicant: Panasonic Automotive Systems Company of America, Division of Panasonic Corporation of North America, PEACHTREE CITY, GA (US)

(72) Inventors: DAVID KAY LAMBERT, STERLING HEIGHTS, MI (US); FIDELIS ITSEDE, ACWORTH, GA (US)

(21) Appl. No.: 18/613,213

(22) Filed: Mar. 22, 2024

Related U.S. Application Data
(60) Provisional application No. 63/454,451, filed on Mar. 24, 2023.

(51) Int. Cl. G08G 1/16; B60W 30/095; B60W 50/14; G06V 20/52; H04W 4/46

(52) U.S. Cl. CPC G08G 1/162; B60W 30/0956; B60W 50/14; G06V 20/52; G08G 1/166; H04W 4/46; B60W 2050/143; B60W 2050/146; B60W 2556/65; G06V 2201/08

(57) ABSTRACT

A safety information arrangement is for installation in a first motor vehicle. The arrangement includes a user interface, a receiver, and an electronic processor. The receiver receives a wireless first signal from outside of the first motor vehicle. The wireless first signal is indicative of a second motor vehicle having an elevated likelihood of colliding with the first motor vehicle. An electronic processor is communicatively coupled to the user interface and to the receiver. The electronic processor receives a second signal from the receiver. The second signal is dependent upon the wireless first signal. The electronic processor controls the user interface dependent upon the second signal to thereby present an alert to a driver of the first motor vehicle. The alert warns the driver that the second motor vehicle has the elevated likelihood of colliding with the first motor vehicle.

### CROSS-REFERENCED TO RELATED APPLICATIONS

This application claims benefit of U.S. Provisional Application No. 63/454,451, filed on Mar. 24, 2023, the disclosure of which is hereby incorporated by reference in its entirety for all purposes.

### BACKGROUND OF THE INVENTION

### 1. Field of the Invention

The present invention relates to a safety information system in a motor vehicle.

### 2. Description of the Related Art

A head up display emits light that reflects from the front windshield to be seen by the driver. The light appears to come from a virtual image in front of the driver and in front of the windshield. This type of head up display is currently commercially available.

Conventional head up displays create the virtual image by first using a display or picture generation unit to create an image. Next, the light from the image is reflected from one or more mirrors. Next, the light from the mirrors is directed up to the windshield and is then reflected from the windshield towards the driver. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

One cause of traffic accidents is an action taken by the driver of vehicle A, because they are not aware of the state of nearby vehicle B. Currently, in order to ascertain the state of other nearby vehicles, a driver looks for visual signals such as turn signals, brake lights and hazard signals. A driver can also evaluate the motion of the other vehicles in order to predict their intent. If all drivers always indicated their intent by correctly signaling, and if they always obeyed traffic laws, many crashes could be avoided. However, there are drivers who do not use traffic signals before changing lanes. There are also drivers who unexpectedly break traffic laws such as running a stop sign or a traffic light.

### SUMMARY OF THE INVENTION

The invention may use a head-up display to inform the driver of a motor vehicle of the state of other vehicles that are nearby, to help prevent traffic accidents. The invention may alert a driver of a vehicle of the state of another nearby vehicle in order to avoid a crash.

The invention may provide a decrease in traffic crashes along with the associated injuries, deaths, and expense. If proven effective, the invention could be mandated by the government.

The invention comprises, in one form thereof, a safety information arrangement for installation in a first motor vehicle. The arrangement includes a user interface, a receiver, and an electronic processor. The receiver receives a wireless first signal from outside of the first motor vehicle. The wireless first signal is indicative of a second motor vehicle having an elevated likelihood of colliding with the first motor vehicle. An electronic processor is communicatively coupled to the user interface and to the receiver. The electronic processor receives a second signal from the receiver. The second signal is dependent upon the wireless first signal. The electronic processor controls the user interface dependent upon the second signal to thereby present an alert to a driver of the first motor vehicle. The alert warns the driver that the second motor vehicle has the elevated likelihood of colliding with the first motor vehicle.

The invention comprises, in another form thereof, a method for presenting safety information to a human driver of a first motor vehicle. A wireless signal is received from outside of the first motor vehicle. The wireless signal is indicative of a second motor vehicle having an elevated likelihood of colliding with the first motor vehicle. A user interface is controlled within the first vehicle dependent upon the signal to thereby present an alert to a driver of the first motor vehicle. The alert warns the driver that the second motor vehicle has the elevated likelihood of colliding with the first motor vehicle.

The invention comprises, in yet another form thereof, a safety information arrangement for installation in a motor vehicle. The arrangement includes a monitoring system having a sensor detecting a condition within the motor vehicle. The monitoring system includes an electronic processor communicatively coupled to the sensor. The electronic processor evaluates whether the detected condition poses a level of danger to an other vehicle that is higher than normal. If the level of danger is evaluated as being higher than normal, then the electronic processor transmits a first alert signal. A transmitter is communicatively coupled to the electronic processor and receives the first alert signal. In response to receiving the first alert signal, the transmitter transmits a wireless second alert signal to the other vehicle.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic block diagram of one embodiment of a head up display safety information arrangement of the present invention for a motor vehicle.

FIG. 2 is a schematic diagram of one embodiment of a method of the present invention for using a head up display to show the state of another vehicle.

FIG. 3 is a block diagram of another embodiment of a head up display safety information arrangement of the present invention for a motor vehicle.

FIG. 4 is a flow chart of one embodiment of a method of the present invention for presenting safety information to a human driver of a first motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

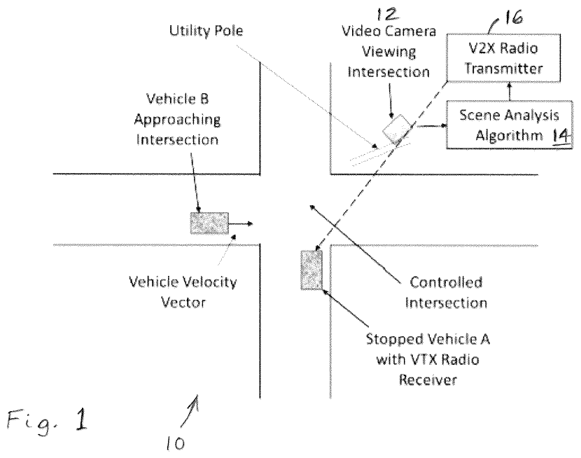

FIG. 1 illustrates one embodiment of a head up display safety information arrangement 10 of the present invention for a motor vehicle A. A video camera 12 is used to monitor an intersection at which traffic is controlled by a stop sign or a traffic light. The video signal from camera 12 is input to an algorithm 14 that determines if an approaching vehicle is stopping or not. If an approaching vehicle is not stopping, then a video transmitter (VTX) radio warning is sent by V2X radio transmitter 16 to nearby vehicles. The driver of a vehicle stopped at the intersection is warned not to proceed until the situation is resolved.

The invention may involve two steps. The first step is to determine that a nearby vehicle B has a higher-than-average, or elevated likelihood (i.e., probability) of performing an action that will create a crash hazard. The second step is to help the driver of vehicle A avoid a crash with vehicle B that might otherwise be caused by the anticipated action of the driver of vehicle B that may be unexpected by the driver of vehicle A.

For the first step, in one embodiment, video camera 12 monitors, e.g., captures images of, a location where crashes have an increased likelihood, such as an intersection. As shown in FIG. 1, the output from video camera 12 is input to a software system 14 that determines whether vehicle B approaching the intersection is preparing to stop as it should or if it is going to go through the intersection without stopping. Such systems are currently known to the art. If the approaching vehicle B is determined to be going through the intersection without stopping, a vehicle-to-everything (V2X) alert is issued which is received by vehicle A.

For the second step, after vehicle A has received such a V2X alert, the information is communicated to the driver of vehicle A in order to help him to avoid a crash. For example, if vehicle A is stopped at a stop sign, and an alert is received that another vehicle B is approaching the intersection and is not stopping for the stop sign, the driver of vehicle A can be warned to not proceed through the intersection until the hazard is resolved.

In one embodiment, a head up display in vehicle A can display a hazard icon to show that the driver should not proceed through the intersection. Another warning method is to use an audible audio signal to alert the driver.

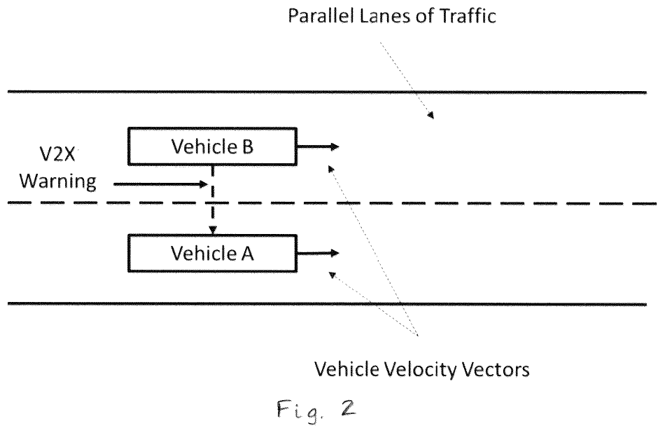

FIG. 2 illustrates one embodiment of a method of the present invention for using a head up display to show the state of another vehicle. This second approach, as shown in FIG. 2, is for vehicle B to self-monitor for risky driver actions with an increased likelihood of leading to a crash, and, if detected, issue an alert to other nearby vehicles. For example, suppose vehicle B begins to move into an adjacent lane without first using the turn signal, vehicle B can issue a V2X alert that may enable vehicle A to avoid a crash. A vehicle system to detect lane departure is known to the art. This invention may use a lane departure warning to alert other nearby vehicles of the lane departure so they can be driven to avoid a crash.

In FIG. 2, two vehicles A and B are travelling the same direction in adjacent lanes. Vehicle B begins to swerve into the lane of vehicle A. As vehicle B begins to enter the lane of vehicle A, the lane departure warning system in vehicle B detects the situation and sends a VTX radio alert to nearby vehicles. The head up display in vehicle A displays the alert to the driver of vehicle A in order to help the driver of vehicle A avoid a crash.

In one embodiment, if vehicle B is moving out of its lane without the driver using their turn signal, and an alert is received by vehicle A, a head up display in vehicle A can alert the driver of vehicle A to steer, brake or accelerate to avoid a crash. In another embodiment, an audible audio signal is used to alert the driver.

In another embodiment, vehicle A has a system that monitors nearby vehicles for evidence of a driver error that increases the probability of a crash with vehicle A. For example, vehicle A could use one or more of video camera(s), radar, or LIDAR to monitor the locations of nearby vehicles. If vehicle B is approaching an intersection, but vehicle B shows evidence of disobeying the traffic light or stop sign, the system warns the driver of vehicle A. The driver of vehicle A may be warned visually via the head-up display or audibly with an audio warning, or both. Similarly, an internal system in vehicle A can monitor the relative positions of nearby vehicles with one or more of video camera(s), radar, or LIDAR. If a nearby vehicle B shows evidence of moving into the lane of vehicle A and causing a crash, the driver of vehicle A can be warned visually by a head-up display or by an audible audio warning.

Additional situations in which a warning about the state of vehicle B received by vehicle A could help prevent a crash include: (1) the driver of vehicle B having a blood-alcohol level that exceeds a predetermined limit, (2) the driver of vehicle B showing evidence of being impaired from the way they are driving, (3) the driver of vehicle B having a history of crashes or traffic citations, (4) vehicle B being in a skid, and (5) vehicle B exceeding the speed limit.

In one embodiment, artificial intelligence may be used to process video information to determine if a vehicle approaching an intersection will stop before going through the intersection.

In one embodiment, rather than using a V2X radio system to communicate the alert to a nearby vehicle, the alert could be sent and received with infrared signals. A visual alert could also be provided.

In one embodiment, nearby drivers are visually warned of a safety hazard such as skidding or a vehicle malfunction such as an over-heated engine that is likely to cause the vehicle to stop. One such embodiment would be to activate the hazard lights on the transmitting vehicle and/or the receiving vehicle if such a situation is detected.

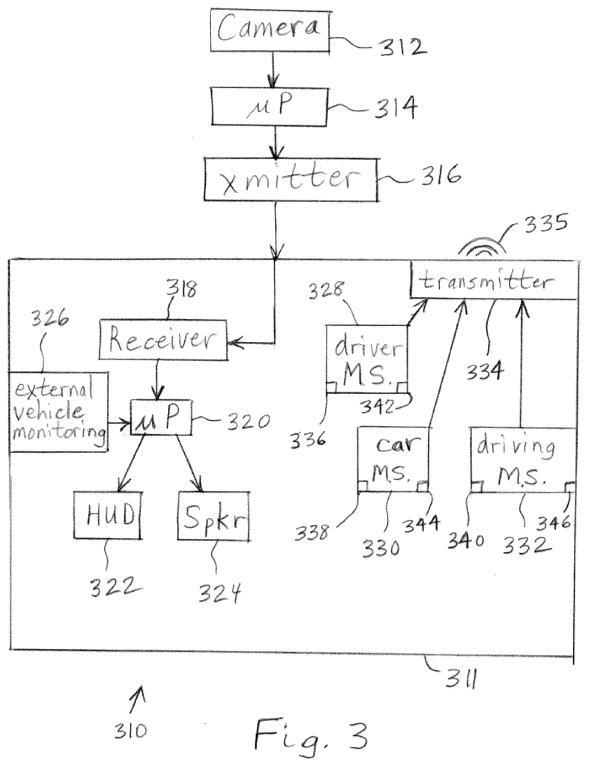

FIG. 3 is a block diagram of another embodiment of a head up display safety information arrangement 310 of the present invention for a motor vehicle 311. Camera 312 may capture images of other vehicles traveling along a road. The images may be analyzed by electronic processor 314 to determine whether any of the other vehicles present an unusually high risk of endangering vehicle 311, e.g., crashing into vehicle 311. If so, radio frequency transmitter 316 emits a radio frequency signal to alert vehicle 311 and other nearby vehicles of the danger.

The radio frequency (RF) signal from transmitter 316 may be received by receiver 318 of vehicle 311. An electronic processor 320 evaluates the received signal and may alert the driver of vehicle 311 of the danger by presenting a warning on a user interface. For example, a visible warning may be presented on head up display 322 and/or an audible warning may be presented via loudspeaker 324.

External vehicle monitoring system 326 may include cameras, radar-based sensors, and/or LIDAR-based sensors to detect the movements of nearby vehicles. Signals indicative of detected vehicle movements are transmitted by system 326 to processor 320. Processor 320 evaluates the received signals to detect erratic driving, and, if erratic driving is detected, may alert the driver of vehicle 311 of the danger by presenting a visible warning on head up display 322 and/or an audible warning on loudspeaker 324.

Vehicle 311 also includes a driver monitoring system 328 for monitoring the driver of vehicle 311. System 328 may include interior/passenger compartment cameras for detecting the driver not watching the road or closing his eyes as a sign of drowsiness. System 328 may also include body sensors to detect heart rate, breathing rate, and intoxication, for example. System 328 may further include an electronic processor for evaluating the data collected by system 328.

A vehicle monitoring system 330 may detect whether vehicle 311 is operating properly, and may include temperature sensors, fluid sensors, voltage meters, and/or sensors that detect whether headlights and/or brake lights are in proper operating condition, for example. System 330 may further include an electronic processor for evaluating the data collected by system 330.

A driving monitoring system 332 may detect whether vehicle 311 is being driven in a safe manner, and may include lane change sensors, turn signal sensors, speedometers, brake sensors and/or external-view cameras, for example. System 332 may further include an electronic processor for evaluating the data collected by system 332. Each of systems 328, 330, 332 may include at least one respective sensor 336, 338, 340 for detecting a condition within vehicle 311, and a respective electronic processor 342, 344, 346 for evaluating whether the condition detected by the respective sensor poses an unusually high level of danger to another nearby motor vehicle.

If any of systems 328, 330, 332 determines that vehicle 311 presents a danger to other nearby vehicles, the system may send an alert signal to a radio frequency transmitter 334. Transmitter may then emit a radio frequency alert signal, as indicated at 335, that may be received by the nearby vehicles in order to alert their drivers of the danger presented by vehicle 311.

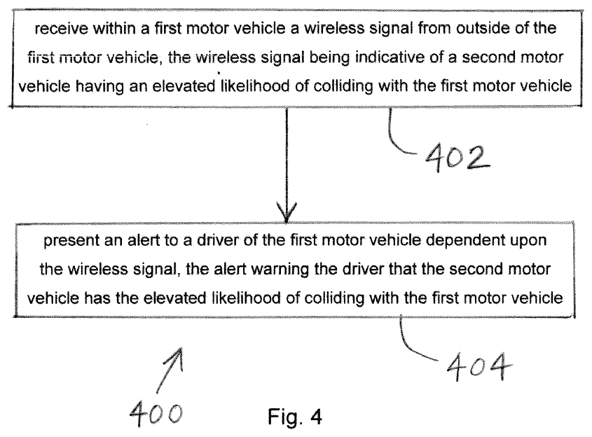

FIG. 4 illustrates one embodiment of a method 400 of the present invention for presenting safety information to a human driver of a first motor vehicle. In a first step 402, a wireless signal is received within the first motor vehicle from outside of the first motor vehicle. The wireless signal is indicative of a second motor vehicle having an elevated likelihood of colliding with the first motor vehicle. For example, if an approaching vehicle B is determined by an algorithm 14 to be going through an intersection without stopping, a vehicle-to-everything (V2X) alert is issued by transmitter 16 and is received by vehicle A.

In a final step 404, an alert is presented to a driver of the first motor vehicle dependent upon the wireless signal, the alert warning the driver that the second motor vehicle has the elevated likelihood of colliding with the first motor vehicle. For example, a head up display in vehicle A can display a hazard icon to show that the driver should not proceed through the intersection because doing so could result in a collision with vehicle B. Another warning method is to use an audible audio signal to alert the driver.

The invention has been described as evaluating whether one vehicle poses an unusually high level of danger to another motor vehicle. This evaluation can be performed by an electronic processor based on collected data with reference to a lookup table. It is also possible for the processor to perform the evaluation based on collected data entered into a formula. It is further possible for artificial intelligence trained on existing crash data to evaluate the probability of an imminent crash based on currently collected data.

The invention has been described herein as presenting visual information on a head up display. However, it is to be understood that the visual information can also be presented on an instrument panel or display screen of the motor vehicle,

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A safety information arrangement for installation in a first motor vehicle, the arrangement comprising:
a user interface;
a receiver configured to receive a wireless first signal from outside of the first motor vehicle, the wireless first signal being indicative of a second motor vehicle having an elevated likelihood of colliding with the first motor vehicle;
an electronic processor communicatively coupled to the user interface and to the receiver, the electronic processor being configured to:
receive a second signal from the receiver, the second signal being dependent upon the wireless first signal; and
control the user interface dependent upon the second signal to thereby present an alert to a driver of the first motor vehicle, the alert warning the driver that the second motor vehicle has the elevated likelihood of colliding with the first motor vehicle.

2. The arrangement of claim 1 wherein the user interface includes a head up display.

3. The arrangement of claim 1 wherein the user interface includes a loudspeaker.

4. The arrangement of claim 1 wherein the electronic processor comprises a first electronic processor, the wireless first signal being received from a second electronic processor that analyzes images of the second motor vehicle captured by a camera and that decides to transmit the wireless first signal based upon a speed and location of the second motor vehicle as determined by the analysis of the images of the second motor vehicle.

5. The arrangement of claim 4 wherein the second electronic processor decides to transmit the wireless first signal based upon a determination that the second vehicle will not stop at a red light or at a stop sign.

6. The arrangement of claim 5 wherein the second electronic processor transmits the wireless first signal via a V2X radio transmitter.

7. The arrangement of claim 1 further comprising an external monitoring system communicatively coupled to the electronic processor and configured to:
evaluate whether the second motor vehicle has an elevated likelihood of colliding with the first motor vehicle; and
if the second motor vehicle has an elevated likelihood of colliding with the first motor vehicle, then issue a third signal indicative of the elevated likelihood, the electronic processor being configured to:
receive the third signal from the external monitoring system; and
control the user interface dependent upon the third signal to thereby present an alert to a driver of the first motor vehicle, the alert warning the driver that the second motor vehicle has the elevated likelihood of colliding with the first motor vehicle.

8. A method for presenting safety information to a human driver of a first motor vehicle, the method comprising:
receiving a wireless signal from outside of the first motor vehicle, the wireless signal being indicative of a second motor vehicle having an elevated likelihood of colliding with the first motor vehicle; and
presenting an alert to a driver of the first motor vehicle dependent upon the wireless signal, the alert warning the driver that the second motor vehicle has the elevated likelihood of colliding with the first motor vehicle.

9. The method of claim 8 wherein the alert is visibly presented to the driver on a head up display.

10. The method of claim 8 wherein the alert is audibly presented to the driver on a loudspeaker.

11. The method of claim 8 wherein the wireless signal is received from an electronic processor that analyzes images of the second motor vehicle captured by a camera and that decides to transmit the wireless signal based upon a speed and location of the second motor vehicle as determined by the analysis of the images of the second motor vehicle.

12. The method of claim 11 wherein the electronic processor decides to transmit the wireless signal based upon a determination that the second vehicle will not stop at a red light or at a stop sign.

13. The method of claim 12 wherein the electronic processor transmits the wireless first signal via a V2X radio transmitter.

14. The method of claim 8 further comprising:
using an external monitoring system of the first motor vehicle to evaluate whether the second motor vehicle has an elevated likelihood of colliding with the first motor vehicle; and
if the external monitoring system determines that the second motor vehicle has an elevated likelihood of colliding with the first motor vehicle, then presenting an alert to the driver of the first motor vehicle, the alert warning the driver that the second motor vehicle has the elevated likelihood of colliding with the first motor vehicle.

15. A safety information arrangement for installation in a motor vehicle, the arrangement comprising:
a monitoring system including:
a sensor configured to detect a condition within the motor vehicle;
an electronic processor communicatively coupled to the sensor and configured to:
evaluate whether the detected condition poses a level of danger to an other vehicle that is higher than normal; and
if the level of danger is evaluated as being higher than normal, then transmit a first alert signal; and
a transmitter communicatively coupled to the electronic processor and configured to:
receive the first alert signal; and
in response to receiving the first alert signal, transmit a wireless second alert signal to the other vehicle.

16. The arrangement of claim 15 wherein the monitoring system is configured to evaluate a condition of a driver of the motor vehicle.

17. The arrangement of claim 15 wherein the monitoring system is configured to evaluate a condition of a component of the motor vehicle.

18. The arrangement of claim 17 wherein the monitoring system includes sensors that detect whether headlights and/or brake lights of the motor vehicle are in proper operating condition.

19. The arrangement of claim 15 wherein the monitoring system is configured to evaluate whether the motor vehicle is being driven safely.

20. The arrangement of claim 19 wherein the monitoring system includes sensors that detect whether the motor vehicle will be able to stop before running through a red light or a stop sign, the sensors detecting a speed of the motor vehicle and a distance to the red light or stop sign.
